(19) United States
(12) Patent Application Publication
(10) Pub. No.: US 2002/0186202 A1
(43) Pub. Date: Dec. 12, 2002

(54) Notebook computer with a web pad equipped display

(76) Inventor: Yu-Fu Huang, Taoyuan (TW)

Correspondence Address: RABIN & BERDO, P.C., Suite 500, 1101 14th Street, N.W., Washington, DC, 20005, US

(21) Appl. No.: 10/084,346

(22) Filed: Feb. 28, 2002

(30) Foreign Application Priority Data
Jun. 6, 2001 (TW) 90209419

(51) Int. Cl. G09G 5/00

(52) U.S. Cl. 345/156

(57) ABSTRACT

A notebook computer comprising a base unit and a display, wherein the display is detachable from the base unit, and can close to and open from the base unit when jointed together is provided. Of which, the display comprises a display panel, a motherboard, a microprocessor and a telecommunication device, wherein the motherboard on which the microprocessor is situated is electrically connected to the display panel while the telecommunication device is electrically connected to the motherboard. The design of the display according to the invention can be attached to and detached from the motherboard, or even can be separated from the notebook computer to be used as an independent web pad providing two uses in an appliance which is indeed convenient to operate.

This application incorporates by reference Taiwanese application Serial No. 90209419, Filed Jun. 6, 2001.

### BACKGROUND OF THE INVENTION

1. Field of the Invention

The invention relates in general to a notebook computer, and more particularly to a notebook computer with a web pad equipped display.

2. Description of the Related Art

Living in an age with rapid growth of information, people can surf the Internet to browse web sites and access needed information thereby via the connection to a Local Area Network (LAN) using a computer. Therefore, the incorporation of the computer and the Internet has become an indispensable function to ordinary people in their every day life activities. However, the heavy weight, big size and portable unfriendly features of a computer as well as the geological restriction of a LAN are indeed very inconvenient to those users who need to surf the Internet whenever and wherever it is needed. In response to this need, a notebook computer with telecommunication device comes to the fore. Its features of portability and being free of geological restriction allowing the user to surf the Internet and search the web sites for information whenever and wherever it is needed. Its configuration of a conventional notebook computer will be disclosed below.

Referring to FIG. 1, a three-dimensional schematic diagram of a conventional notebook computer is illustrated. In FIG. 1, the notebook computer 100 comprises a base unit 102 and a display 104, wherein the display 104, which is jointed to the base unit 102 via a pivotal spindle 106, has a display panel 108 such as a Liquid Crystal Display (LCD) on which signals are displayed. The base unit 102 further comprises a base unit's top face 110, a keyboard session 112, a motherboard 114, a memory unit 115, a hard disk 117 and a Central Processing Unit (CPU) 116. Of which, the keyboard 112 with which the users input their operation signals is situated at an opening 118 of the base unit's top face 110; the motherboard 114, memory unit 115, CPU 116 and the hard disk 117 as well are installed inside the base unit 102 whereas the memory unit 115 and the CPU 116 are installed on the motherboard 114. As for how the notebook computer 100 is connected to the Internet can be done by installing a wireless telecommunication device (not shown in the diagram) in the notebook computer 100 or connecting the notebook computer 100 to the Internet using the Bluetooth technology. In either way, the user, using the notebook computer 100, can surf the Internet browsing web sites or even download information to the hard disk 117 from the web sites.

It is true that the notebook computer is portable and convenient. However, for those Internet surfers, only the Internet surfing function is needed: they do not need the full-range functions of a notebook computer. Therefore, an Internet surfing web pad, which satisfies users' needs of Internet surfing and information searching, comes to the fore. The hardware configuration and features of a web pad is disclosed below.

Referring to FIG. 2A, a three-dimensional schematic diagram of a web pad is illustrated. The web pad 200 comprises a casing 202, a display panel 204, a motherboard 206, a Central Processing Unit (CPU) 208, a memory unit 210 and a stylus 212. Of which, the casing 202 has a chamber 214 in which the display panel 204, a Liquid Crystal Display (LCD) for instance, is accommodated; the motherboard 204, CPU 208 and the memory unit 210 as well are all situated inside the casing 202. The user can input signals by touching the surface of the display panel 204 using the stylus 212. Having finished their use of the web pad, the user only need to insert the stylus 212 into a stylus slot 216 alongside the casing 202 in the direction of the arrow lest the stylus 212 might be misplaced.

Referring to FIG. 2B, a side elevation of the web pad in FIG. 1A is illustrated. In FIG. 2B, both the CPU 208 and the memory unit 210 are installed on the motherboard 202, whereas the CPU 208 and the memory unit 210 are situated beneath the display panel 204. As for how the web pad 200 is connected to the Internet can be done by installing a wireless telecommunication device (not shown in the diagram) in the web pad 200 or connecting the web pad 200 to the Internet using the Bluetooth technology. In either way, the user, using the web pad 200, can surf the Internet searching the web sites. Moreover, the web pad 200, being compacter and smaller than the notebook computer 100 in FIG. 1, can really satisfy those users who only need to surf the Internet to search for information providing the user with more convenience in Internet surfing.

It is to be understood that despite the convenience of Internet surfing and web site searching, the web pad 200 does not provide the function of e-mailing as the notebook computer 100 does. Besides, the web pad 200 has not been equipped with the keyboard 112 with which the user can key in information and the hard disk 117 into which information from the web sites is downloaded as the notebook computer 100 in FIG. 1 has. As a consequence, the user can only surf the Internet browsing the web sites, but the user cannot send e-mail nor can he or she download their needed information limiting the use of the web pad.

SUMMARY OF THE INVENTION

It is therefore an object of the invention to provide a notebook computer with a web pad equipped display. The design of the display according to the invention can be attached to and detached from the motherboard, or even can be separated from the notebook computer to be used as an independent web pad providing two uses in an appliance which is indeed convenient to operate.

According to the object of the invention, a notebook computer comprising a base unit and a display, wherein the display is detachable from the base unit, and can close to and open from the base unit when jointed together is provided. Of which, the display comprising a display panel, a motherboard, a microprocessor and a telecommunication device, wherein the motherboard is electrically connected to the display panel while the microprocessor is situated on the motherboard and the telecommunication device is electrically connected to the motherboard.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a three-dimensional schematic diagram of a conventional notebook computer;

FIG. 2A shows a three-dimensional schematic diagram of a web pad;

FIG. 2B shows a side elevation of the web pad in FIG. 2A; and

FIG. 3 shows a notebook computer with web pad equipped display according to a preferred embodiment of the invention.

### DESCRIPTION OF THE PREFERRED EMBODIMENT

A notebook computer with a web pad equipped display is designed in the invention. That is, a web pad is used to replace the display of a conventional notebook computer. When jointed to the base unit, the web pad can close to and open from the base unit as if the base unit is a docking to the web pad. By doing so, the notebook computer with a web pad equipped display allows the user to e-mail and download information from the web sites. As for the practical application is disclosed in a preferred embodiment.

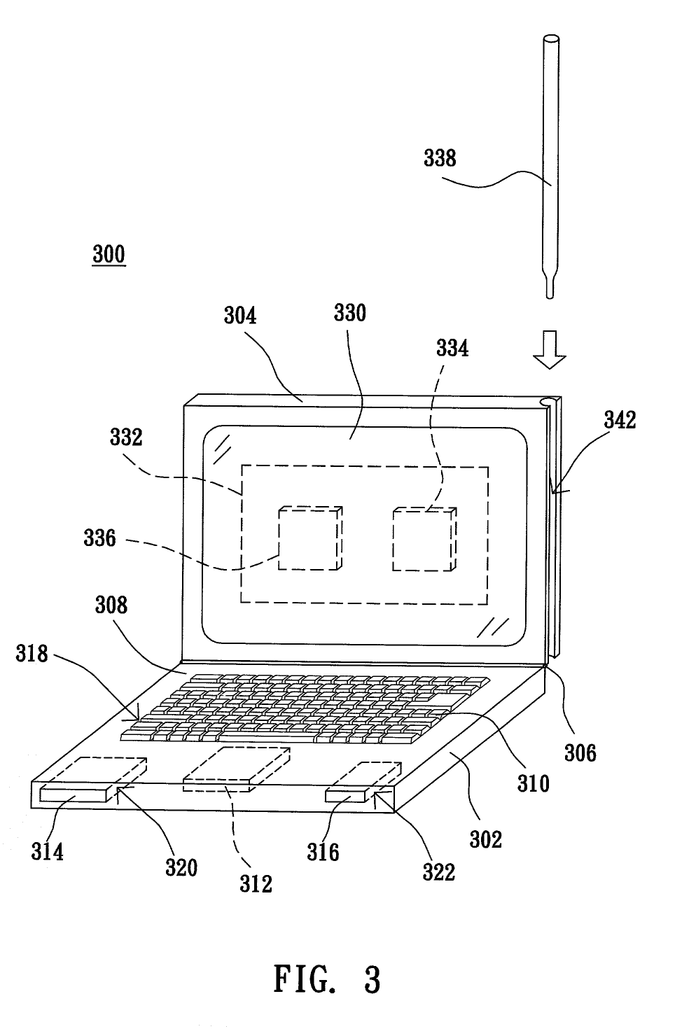

Referring to FIG. 3, a three-dimensional schematic diagram of a notebook computer with a web pad equipped display according to a preferred embodiment of the invention is illustrated. In FIG. 3, the notebook computer 300 comprises a base unit 302 and a display 304, wherein the display 304 is jointed to the base unit 302 using a linking device 306. The linking device 306 can be a pivotal spindle so the display 304 can close to and open from the base unit 302 or even can be detached from the base unit 302. The base unit 302 further comprises a base unit's top face 308, a keyboard 310, a hard disk 312, a CD-ROM 314 and a floppy disk drive 316. Of which, the keyboard 310 with which the user keys in operation signals is situated in an opening 318 of the base unit's top face 308, whereas the hard disk 312 in which the notebook computer 300 stores its information is situated inside the base unit 302. Apart from that, the CD-ROM 314 and the floppy disk drive 316 with which the notebook computer 300 reads a compact disk and a floppy disk are respectively located at slots 320and 322 of the base unit 302.

It is noteworthy that the display 304 is a so-called ‘web pad’. The display 304 further comprises a display panel 330, a motherboard 332, a memory unit 336, a stylus 338 and a microprocessor. The microprocessor can be a Central Processing Unit (CPU) 334 whereas the display 304 has a chamber 340 used to accommodate a display panel 330, a Liquid Crystal Display (LCD) for instance. Of which, the motherboard 332, CPU 334 and the memory unit 336 are all situated inside the display 304. The display 304 becomes an independent web pad if it is separated from the base unit 302 via the linking device. The user can input signals by touching the surface of the display panel 330 using the stylus 338. Having finished their use of the web pad the user only needs to insert the stylus 338 into a stylus slot 342 alongside the display 304 in the direction of the arrow lest the stylus 338 might be misplaced.

The web pad equipped display 304 in the invention can be directly separated from the base unit 302, which allows the user to surf the Internet and browse the web sites only. How is the display 304 connected to the Internet? This is usually done by installing a wireless telecommunication device (not shown in the diagram) in the display 304 or using the Bluetooth technology. So the user is able to use the display 304 directly to surf the Internet and search the web sites.

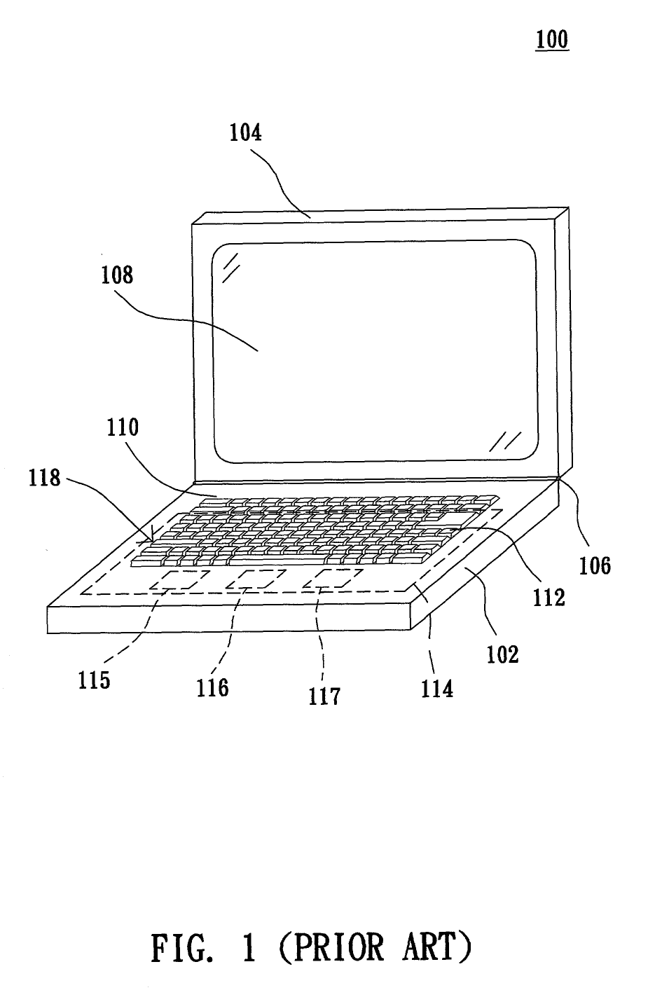

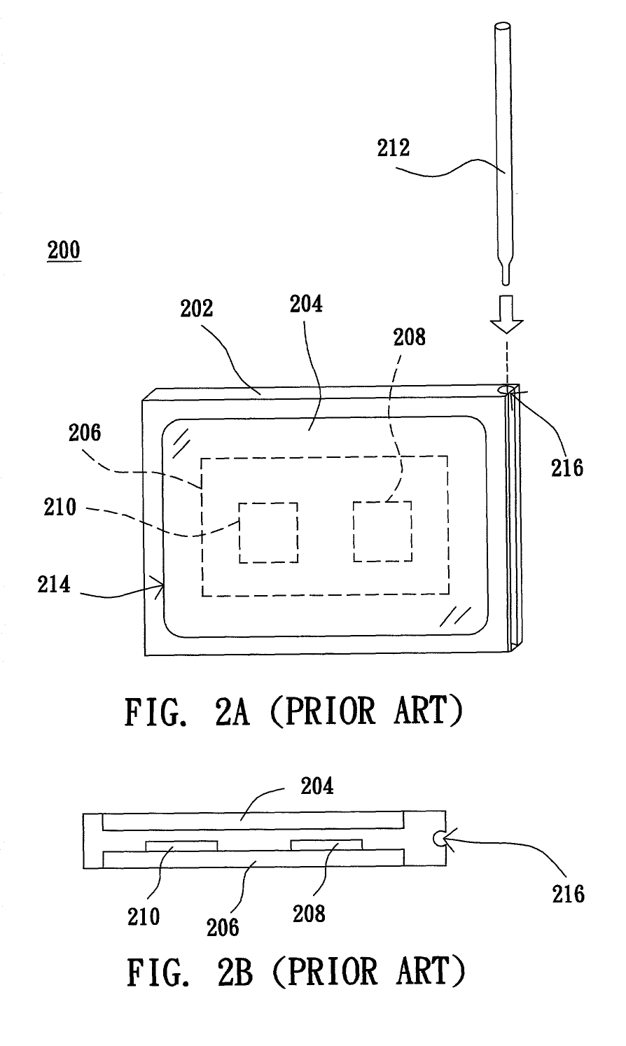

Since the motherboard 332, CPU 334 and memory unit 336 have already been transplanted to the web pad equipped display 304 from the base unit 102 of the notebook computer 100 in FIG. 1, the display 304 has virtually become a so-called ‘System Box’. Therefore, the design with the CPU 334 being situated inside the display 304 avoids the heat produced during operation being transmitted to the user's lap. Moreover, the base unit 302 in the invention comprising storage devices such as the keyboard 310, hard disk 312, CD-ROM 314 and floppy disk drive 316 has virtually become an Input/Output Box (I/O Box). It is noteworthy that the equipment inside the I/O Box and System Box can be upgraded respectively without causing mutual interferences. So there is no need for the user to change to a new set of notebook computer if he or she would like to upgrade their notebook computer thus saving a considerable amount of cost.

The design of the display according to the invention can be attached to and detached from the motherboard, or even can be separated from the notebook computer to be used as an independent web pad providing two uses in an appliance which is indeed convenient to operate.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A notebook computer with a web pad equipped display, comprising:
a base unit; and
a display, which is detachable from the base unit and can close to and open from the base unit when jointed to the base unit, wherein the display comprises:
a display panel;
a motherboard which is electrically connected to the display panel;
a microprocessor which is situated on the motherboard; and
a telecommunication device which is electrically connected to the motherboard.

2. A notebook computer according to claim 1, wherein the display is a web pad.

3. A notebook computer according to claim 1, wherein the display further comprises:
a memory unit which is situated on the motherboard.

4. A notebook computer according to claim 1, wherein the display further comprises:
a stylus with which the user uses to touch the display panel to input control signals can be inserted into a stylus slot of the display.

5. A notebook computer according to claim 1, wherein the display panel is a Liquid Crystal Display (LCD).

6. A notebook computer according to claim 1, wherein the telecommunication device is a wireless telecommunication device.

7. A notebook computer according to claim 1, wherein the transmission of the telecommunication device is a Bluetooth transmission.
